(19) United States
(12) Patent Application Publication
(10) Pub. No.: US 2009/0035638 A1
(43) Pub. Date: Feb. 5, 2009

(54) FUEL CELL MODULE

(76) Inventors: Ming-Chou Tsai, Taipei County (TW); Yu-Chih Lin, Kao-Hsiung City (TW); Jiun-Ming Chen, Taipei County (TW); Chiang-Wen Lai, Tao-Yuan City (TW); Ching-Sen Yang, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/061,656

(22) Filed: Apr. 3, 2008

(30) Foreign Application Priority Data
Aug. 1, 2007 (TW) 096128234
Jan. 24, 2008 (TW) 097102619

(51) Int. Cl. H01M 8/10; H01M 8/04

(52) U.S. Cl. 429/30; 429/34

(57) ABSTRACT

A fuel cell module includes an integral anode plate, a cathode plate, an array membrane electrode assembly (array MEA) and a pre-molded adhesive plate. The integral anode plate includes a flow board. A recess is disposed on a side of the flow board for accommodating a bendable lug of a unitary anode charge collector. The bendable lug is electrically connected to a cathode charge collector on the cathode board. The array MEA includes a plurality of MEA units and a proton exchange membrane. The pre-molded adhesive plate has openings for accommodating corresponding MEA units. The pre-molded adhesive plate has an intermediate rigid frame sandwiched between two adhesive layers.

### BACKGROUND OF THE INVENTION

1. Field of the Invention

The present invention relates generally to the field of fuel cell technology and, more particularly, to a flat-panel direct methanol fuel cell module capable of solving the fuel leakage problem.

2. Description of the Prior Art

A fuel cell is an electrochemical cell in which a free energy change resulting from a fuel oxidation reaction is converted into electrical energy. Fuel cells utilizing methanol as fuel are typically named as Direct Methanol Fuel cells (DMFCs), which generate electricity by combining gaseous or aqueous methanol with air. DMFC technology has become widely accepted as a viable fuel cell technology that offers itself to many application fields such as electronic apparatuses, vehicles, military equipments, aerospace industry and so on.

DMFCs, like ordinary batteries, provide dc electricity from two electrochemical reactions. These reactions occur at electrodes (or poles) to which reactants are continuously fed. The negative electrode (anode) is maintained by supplying methanol, whereas the positive electrode (cathode) is maintained by the supply of air. When providing current, methanol is electrochemically oxidized at the anode electrocatalyst to produce electrons, which travel through the external circuit to the cathode electrocatalyst where they are consumed together with oxygen in a reduction reaction. The circuit is maintained within the cell by the conduction of protons in the electrolyte. One molecule of methanol (CH₃OH) and one molecule of water (H₂O) together store six atoms of hydrogen. When fed as a mixture into a DMFC, they react to generate one molecule of CO₂, 6 protons (H⁺), and 6 electrons to generate a flow of electric current. The protons and electrons generated by methanol and water react with oxygen to generate water. The methanol-water mixture provides an easy means of storing and transporting hydrogen, much better than storing liquid or gaseous hydrogen in storage tanks.

The DMFC module usually includes a current collector (or also referred to as charge collector board) and a flow board, which both play important roles. The current collector collects the electrons generated from the electron-chemical reaction, and the flow board manages and controls the distribution of the fuel. In the past, the flow board design has focused on enabling fuel to pass smoothly through the fuel channel into the membrane electrode assembly (MEA).

Hitherto, the flat-panel direct methanol fuel cell has been developed into a mature phase and has relatively higher performance and reliability. However, the prior art flat-panel direct methanol fuel cell still has several drawbacks such as fuel leakage. There is a need to provide an improved flat-panel direct methanol fuel cell module capable of solving the aforesaid prior art problems.

### SUMMARY OF THE INVENTION

In view of the above reasons, the main purpose of the present invention is providing an improved fuel cell module in order to promote the safety of the fuel cell module.

According to the claimed invention, a fuel cell module includes an integral anode plate, a cathode plate, an array membrane electrode assembly (array MEA) and a pre-molded adhesive plate. The integral anode plate includes a flow board. A recess is disposed on a side of the flow board for accommodating a bendable lug of a unitary anode charge collector. The bendable lug is electrically connected to a cathode charge collector on the cathode board. The array MEA includes a plurality of MEA units and a proton exchange membrane. The pre-molded adhesive plate has openings for accommodating corresponding MEA units. The pre-molded adhesive plate has an intermediate rigid frame sandwiched between two adhesive layers.

From another aspect, a fuel cell module includes an anode board made of rigid-flex board, wherein the anode board comprises an anode charge collector and a bendable conductive lug, and wherein a plurality of through holes are provided on the anode charge collector; a flow board having thereon a plurality of flow channels; a cathode board comprising at least one cathode charge collector; an array membrane electrode assembly (array MEA) interposed between the anode board and the cathode board, wherein the array MEA comprises at least one membrane electrode assembly and a proton exchange membrane; and an adhesive layer interposed between the anode board and the array MEA and between the cathode board and the array MEA, wherein the adhesive layer has an opening corresponding to the MEA.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic, exploded diagram illustrating the fuel cell module in accordance with one preferred embodiment of this invention.

FIG. 2 is a schematic diagram illustrating a side view of the fuel cell module of FIG. 1 after assembly.

FIG. 3 is a schematic, exploded diagram illustrating the pre-molded adhesive plate of FIG. 1.

FIG. 4 is a schematic, exploded diagram illustrating the integrated anode flow board of FIG. 1.

FIG. 5 is a schematic diagram illustrating a side view of the integrated anode flow board of FIG. 4 after assembly.

FIG. 6 is a side view of the flow board according to this invention.

FIG. 7 is a side view of the flow board in combination with the anode charge collectors.

FIG. 8 is a schematic, cross-sectional view showing the lug and the recess on the flow board according to this invention.

FIG. 9 is a schematic top view of array MEA according to this invention.

FIG. 10 is a perspective view showing a portion of the cathode board according to the preferred embodiment of this invention.

FIG. 11 is an exploded diagram showing the parts of a fuel cell module 1a in accordance with another preferred embodiment of this invention.

FIG. 12 is a perspective view showing the anode board 10a of the fuel cell module 1a of FIG. 11.

FIG. 13 is an assembly diagram of a fuel cell system of this invention.

### DETAILED DESCRIPTION

As previously mentioned, the flat-panel direct methanol fuel cell has been developed into a mature phase and has relatively higher performance and reliability. However, the prior art flat-panel direct methanol fuel cell still has several drawbacks such as fuel leakage. It is believed that the leakage path is the seam between the prepreg intermediate adhesive layer and the MEA (membrane electrode assembly). The fuel leakage usually occurs at the MEA side. The seam is caused by delamination resulting from poor adhesion between the prepreg intermediate adhesive layer and the MEA.

In practical applications, it has been found that the fuel leakage also occurs near the anode charge collector (ACC) side. The possible leakage path in this case may be the interface between the charge collecting sheet and the adjacent adhesive material. The causes of the formation of such leakage path near the ACC side may include the stress originated from the bending of interconnection lugs and difference of the CTEs (coefficients of thermal expansion) between metal and adhesive material. The aforesaid interface may be damaged when performing the thermal shock experiments according to IEC standards.

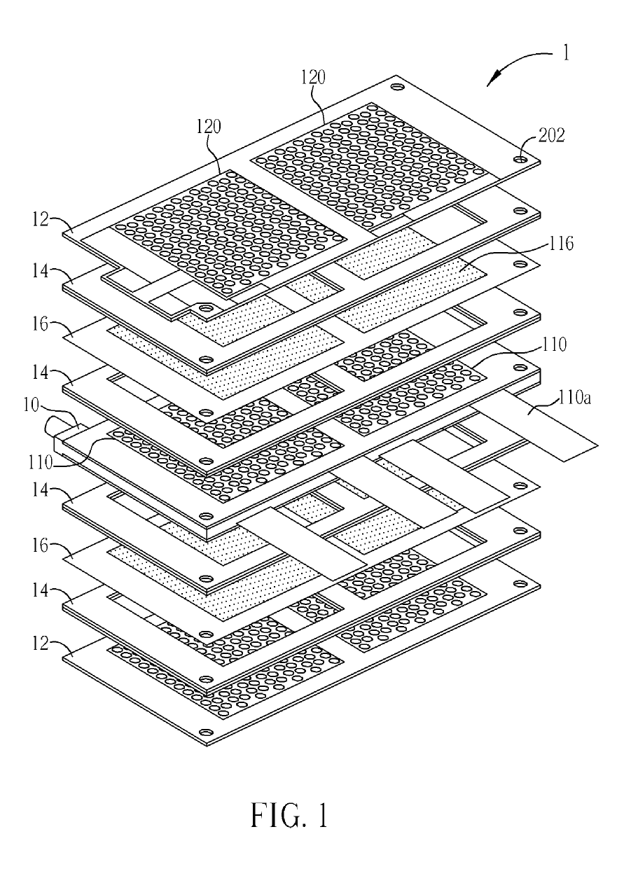

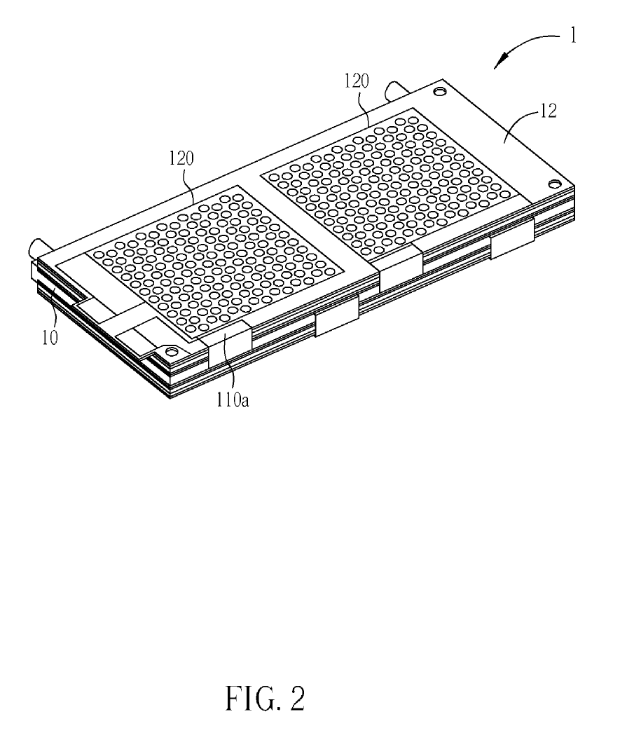

Please refer to FIG. 1 and FIG. 2. FIG. 1 is a schematic, exploded diagram illustrating the fuel cell module 1 (taking a 2W cell as an example) in accordance with one preferred embodiment of this invention. FIG. 2 is a schematic diagram illustrating a side view of the fuel cell module of FIG. 1 after assembly.

As shown in FIG. 1 and FIG. 2, according to the preferred embodiment of this invention, the fuel cell module 1 comprises an integrated anode flow board 10, a cathode board 12 (in contact with air), pre-molded adhesive plate 14, and array MEA 16, which are laminated together.

The aforesaid integrated anode flow board 10 is a combination of an anode board and a flow board. The details of the structure of the integrated anode flow board 10 will be described later. The cathode board 12 may be fabricated by PCB (printed circuit board) processes, or may be made of graphite or metals, but not limited thereto.

The pre-molded adhesive plate 14 and the array MEA 16 are laminated together and the laminated pre-molded adhesive plate 14 and the array MEA 16 are interposed between the integrated anode flow board 10 and the cathode board 12. The pre-molded adhesive plate 14 has openings for accommodating corresponding MEA units 116 of the array MEA 16 such that in operation the two opposite sides of each MEA unit 116 are in direct contact with the anode charge collector 110 of the integrated anode flow board 10 and the cathode charge collector 120 of the cathode board 12, respectively.

The anode charge collector 110 is responsible for collecting electrons generated by oxidizing the methanol of the fuel and the collected electrons are transmitted through the circuitry connecting the charge collectors and the cathode board 12. Through holes are provided on the charge collectors that function as channels for the reactants and products of the fuel cell.

The anode charge collector 110 may be made of metals such as gold, platinum, silver, aluminum, chrome, titanium, cadmium or the like, metal oxides, metal alloys such as various stainless steels. Moreover, the anode charge collector 110 may be made of non-metal materials such as carbon, graphite, FR4, FR5 or any suitable composite materials. The fabrication of the anode charge collectors 110a and 110b may include depositing a conductive layer onto a substrate by electroplating, electroless plating, sputtering, or any suitable chemical or physical deposition methods.

The pre-molded adhesive plate 14 has good and stable adhesion ability to both the substrate material of the integrated anode flow board 10 and the substrate material of the cathode board 12. The substrate material of the anode flow board 10 and the cathode board 12 typically comprises glass fiber or plastic substrate. Preferred examples of the pre-molded adhesive plate 14 include thermal-pressing type prepreg adhesive, which melts at high temperatures to glue the integrated anode flow board 10 and the cathode board 12.

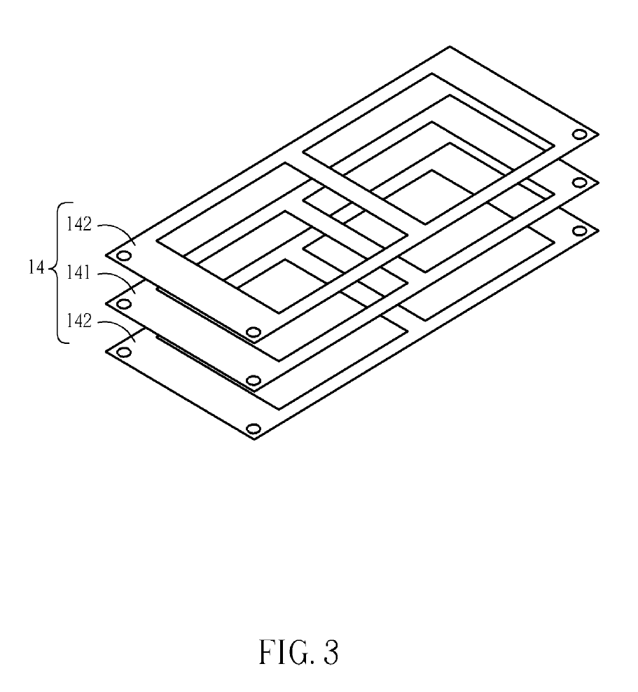

As shown in FIG. 3, in accordance with the preferred embodiment of this invention, the pre-molded adhesive plate 14 comprises a middle frame 141 and adhesive films 142. The middle frame 141 is sandwiched about the two adhesive films 142. Preferably, the middle frame 141 is made of denser materials such as FR5 or the like.

The pre-molded adhesive plate 14 not only provides superior adhesion properties but it also plays an important role in MEA compression control. By adjusting the thickness of the middle frame 141 of the pre-molded adhesive plate 14 or the total number of the pre-molded adhesive plates 14 used in the fuel cell module, the compression of the MEA unit can be well controlled. The adhesive film 142 is preferable a thermo-pressing type adhesive material that have good and stable adhesion ability to the flow board, electrode plates and the MEA. Preferable examples of the adhesive film 142 include, but not limiting to, prepreg, epoxy resins, polyurethane (PU) resins or silicone resins.

According to the preferred embodiment, the array MEA 16 comprises a plurality of MEA units 116 that are all integrated, in an aligned array fashion, on one single proton exchange membrane 16a such as Dupont's Nafion (fluoride type) membrane. It is understood that the proton exchange membrane 16a may be a hydrocarbon type proton exchange membrane. This array MEA 16 facilitates the alignment, lamination and pressing and improves alignment precision during assembly. In addition, by utilizing such unique array MEA 16, the surface area for adhesion outside the MEA units 116 is increased, thereby improving the reliability of the fuel cell module.

In accordance with the preferred embodiment, corresponding positioning through holes 202 are provided on the integrated anode flow board 10, the cathode board 12, the pre-molded adhesive plate 14 and the array MEA 16, for example, the positioning through holes 202 are disposed at corners of each layer. These positioning through holes 202 facilitates the alignment of each layer of the fuel cell module.

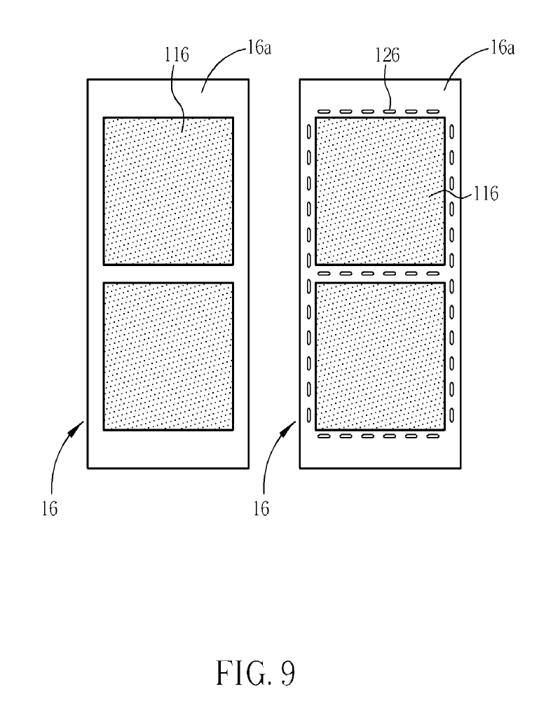

Further, as shown in FIG. 9, the size and the shape of the array MEA 16 is substantially the same with other layers of the fuel cell module. Accordingly, the array MEA 16 is able to provide more surface area for adhesion. In order to improve the interface bond between the array MEA 16 and the pre-molded adhesive plate 14, a plurality of apertures 126 may be disposed on the proton exchange membrane 16a along the perimeter of each MEA unit 116. The apertures 126 allow adhesive or glue to flow therein during pressing and lamination process.

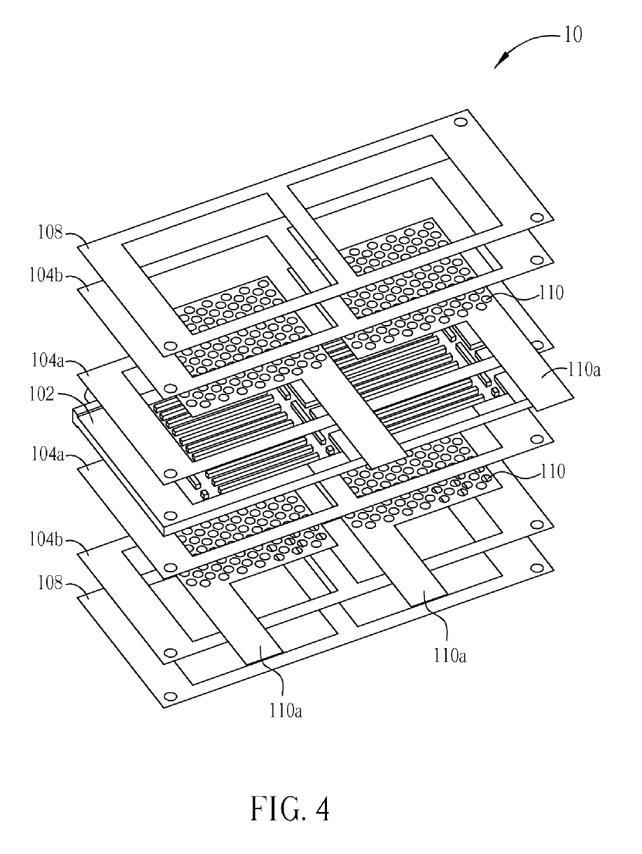

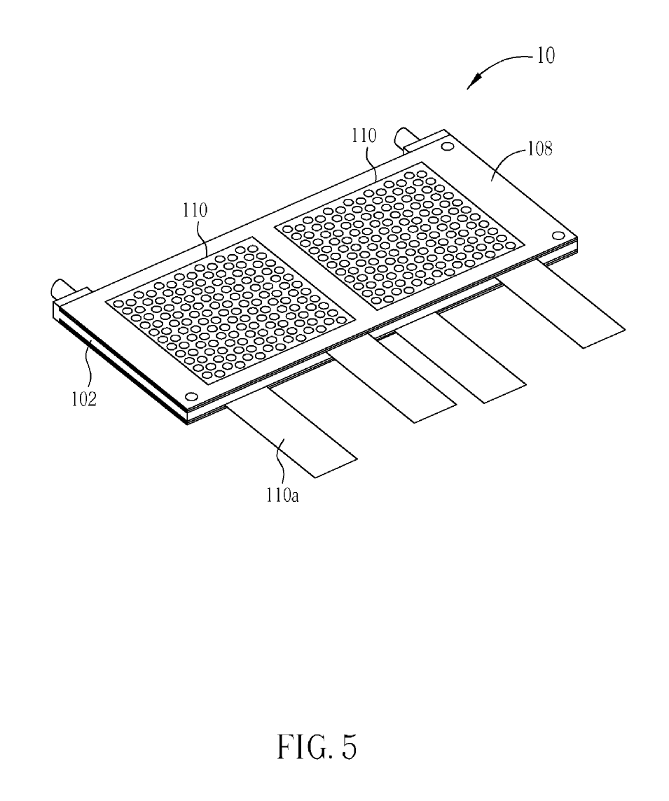

Another distinctive feature of the present invention fuel cell module 1 is that the integrated anode flow board 10 has an improved design capable of avoiding fuel leakage. Please refer to FIG. 4 and FIG. 5. FIG. 4 is a schematic, exploded diagram of the integrated anode flow board 10 of FIG. 1. FIG. 5 is a side view of the integrated anode flow board 10 of FIG. 4 after assembly.

As shown in FIG. 4 and FIG. 5, the integrated anode flow board 10 comprises a flow board 102, adhesive films 104a and 104b, anode charge collectors 110 and frames 108, which are laminated and hot pressed together.

Each of the anode charge collectors 110 has an outward protruding lug 110a that is bendable and is eventually electrically connected to the cathode board 12. After assembly, by bending the lugs 110a the unit cells of the fuel cell module 1 can constitute series or parallel connection configurations. The adhesive films 104a and 104b may comprise prepreg or epoxy resins. The adhesive films 104a and 104b and the frames 108 have corresponding openings that allow the anode charge collectors 110 be exposed after pressing and lamination.

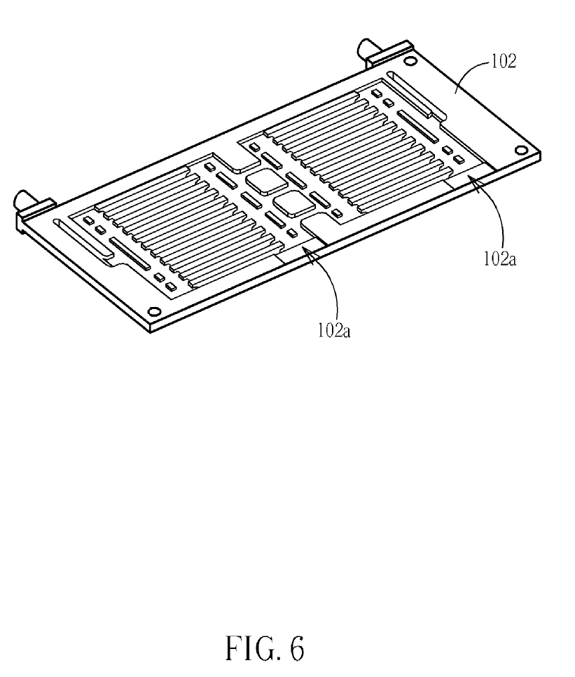

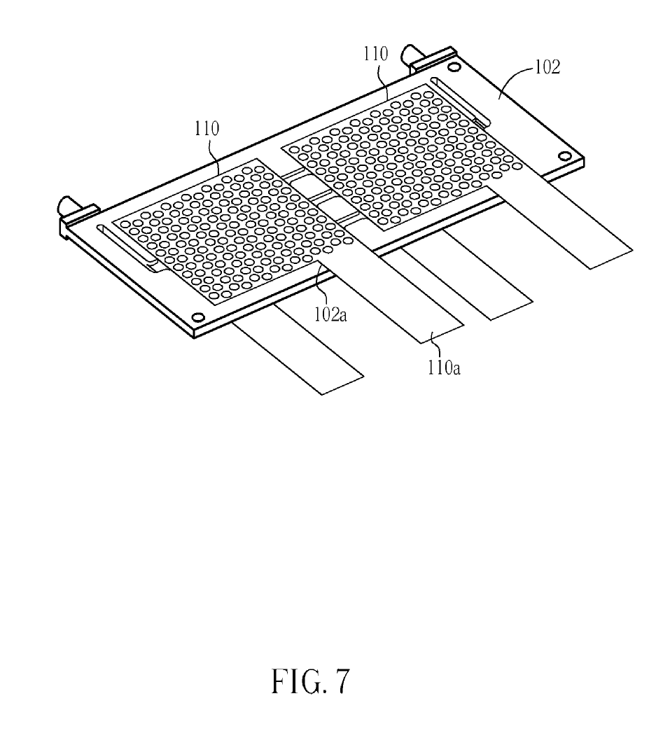

Please refer to FIG. 6 and FIG. 7. FIG. 6 is a side view of the flow board 102 according to this invention. FIG. 7 is a side view of the flow board 102 in combination with the anode charge collectors 110. As shown in FIG. 6 and FIG. 7, the present invention is further characterized in that a recess 102a is provided on the flow board 102 corresponding to the position of the lug 110a of the anode charge collector 110. By providing the recess 102a, the lug 110a can be tightly inlaid and affixed on the flow board 102.

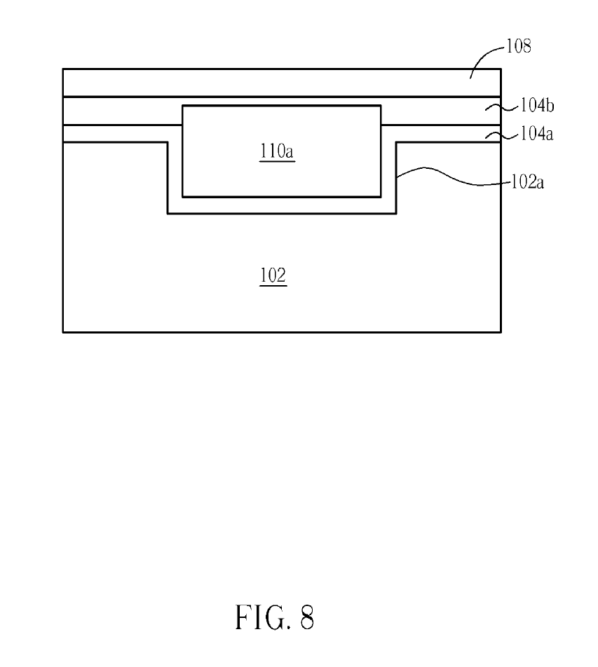

FIG. 8 is a schematic, cross-sectional view showing the lug and the recess on the flow board according to this invention. As shown in FIG. 8, the lug 110a is sandwiched between the adhesive films 104a and 104b within the recess 102a. The adhesive films 104a and 104b encapsulate the lug 110a in the recess 102a. The surface bond between the lug 110a, the adhesive films 104a and 104b and the flow board 102 can be improved, thereby avoiding fuel leakage problem.

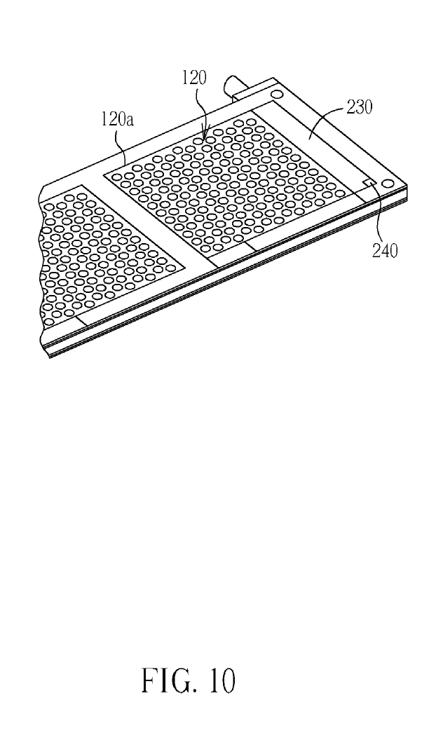

FIG. 10 is a perspective view showing a portion of the cathode board according to the preferred embodiment of this invention. As shown in FIG. 10, the cathode board 12 comprises the cathode charge collector 120 and circuit traces for parallel or serially connecting the cell units, wherein the surface of the cathode charge collector 120 is treated by anti-corrosion methods such that the surface of the cathode charge collector 120 is resistant to electro-chemical corrosion. The cathode board 12 is fabricated by methods that are compatible with standard printed circuit board (PCB) processes. For example, the method for fabricating the cathode board 12 includes cutting copper clad laminate (CCL) substrate into desired size, drilling through holes 120a on the cathode charge collector 120, wherein, preferably, the combined area of the through holes 120a is about 40% the surface area of the cathode charge collector 120, thereafter depositing a chemical copper-plating layer on the CCL substrate and on the interior surface of the through holes 120a, masking the CCL substrate with a dry film to expose the cathode charge collector 120, using the dry film as a plating mask, plating a copper layer and a Sn/Pb layer on the regions that are not covered with the dry film, stripping the dry film, etching away the copper layer and the chemical copper-plating layer from the regions that are not covered with the Sn/Pb layer, and etching away the Sn/Pb layer. To avoid substrate damage or short circuit during subsequent soldering process, a solder resist layer may be applied. Thereafter, a protective layer such as Ni/Au, Sn/Pb or chemical silver is plated on the electrodes.

A metal pattern 230 for radiating heat is disposed on the cathode board 12. The metal pattern 230 may be any dummy metal patterns having large surface area. The metal pattern 230 may be composed of any copper layer of a multi-layer substrate. Moreover, the metal pattern 230 can be utilized as an embedded active circuit for integrating with the energy management system (EMS) that controls the DMFC. Preferably, the layout of the circuit can be adjusted according to the functional demands of the fuel cell.

Furthermore, an electronic device 240 such as capacitors, resistors, inductors, or IC chips may be embedded in or on the surface of the cathode board 12. According to the present embodiment, the electronic device 240 is capable of monitoring temperature of the fuel cells or has short circuit protection function.

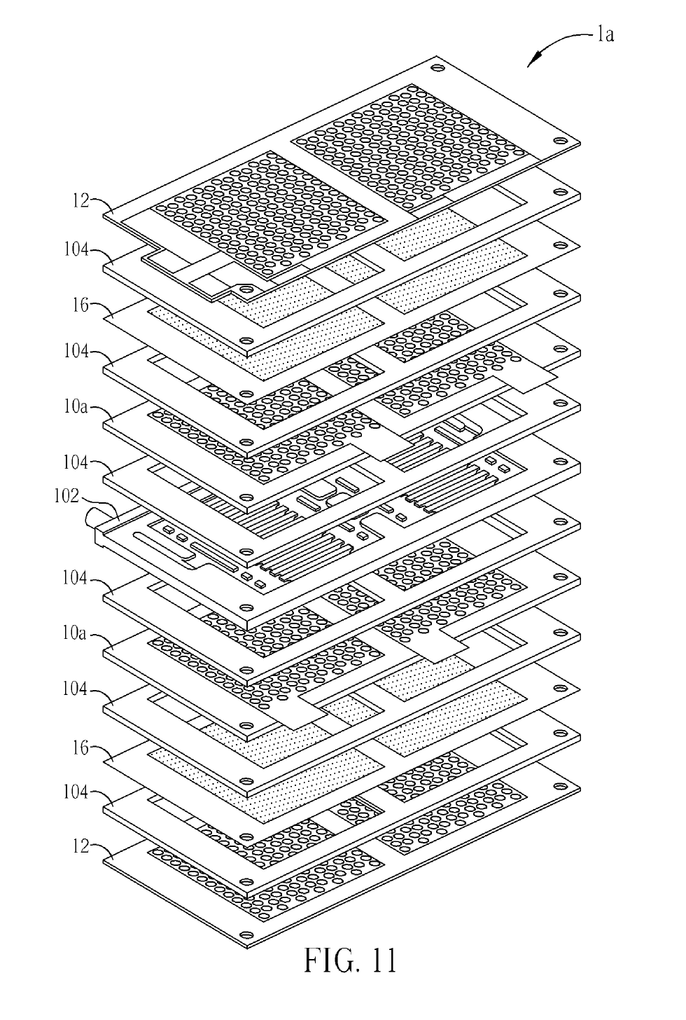

FIG. 11 is an exploded diagram showing the parts of a fuel cell module 1a in accordance with another preferred embodiment of this invention. As shown in FIG. 11, the fuel cell module 1a comprises a stack assembly comprising flow board 102, anode board 10a, cathode board 12, adhesive layer 104 and array MEA 16. The difference between the fuel cell module 1 and the fuel cell module 1a is that the flow board 102 and the anode board 10a of the fuel cell module 1a are not integrated together. By doing this, the hole opening ratio of the charge collecting area on the anode board 10a can be individually designed without the need of considering the factor of flow board.

The design of the flow board is more flexible because the electrode plates of this invention are made from circuit board or metal charge collecting plate. The flow board can meet the requirements of both active and passive fuel cell types without the need of considering MEA support and electric current conducting problems. For example, the flow board may be bar type or serpentine type, but not limited thereto. Further, the flow board 102 of this invention may be single-sided or double-sided. According to the preferred embodiment of the present invention, the body substrate of the flow board 102 may be made by injection molding methods with injection moldable polymer materials, which are able to be molded utilizing said injection molding methods, such as polyetheretherketone (PEEK), polyetherketoneketone (PEKK), Polysulfone (PSU), liquid crystal polymer (LCP), polymer plastic substrate or a compound of engineering plastic. The above-mentioned injection moldable polymer materials may be injected concurrently with filler. The above-mentioned filler could be a modifier, floating agnet, mold-release agent etc.

In FIG. 11, the adhesive layer 104 is thermo-pressing type adhesive sheet and has good and stable adhesion ability to the flow board 102, the anode board 10, the cathode board 12 and the proton exchange membrane of the array MEA 16. Preferred examples of the adhesive layer 104 include prepreg adhesives, epoxy resins, polyurethane (PU) resins or silicone resins. The adhesive layer 104 has openings corresponding to the MEA regions. It is understood that the adhesive layer 104 may be replaced with the pre-molded adhesive plate 14 depicted in FIG. 3.

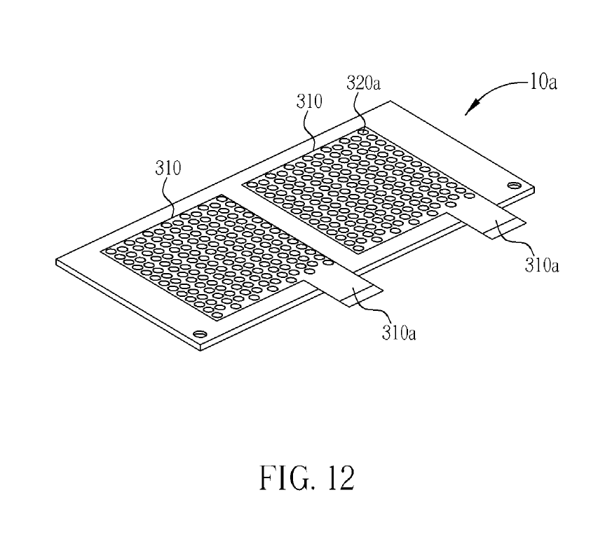

FIG. 12 is a perspective view showing the anode board 10a of the fuel cell module 1a of FIG. 11. As shown in FIG. 12, the anode board 10a comprises the anode charge collector 310 and circuit traces for parallel or serially connecting the cell units. The anode board 10a is fabricated by methods that are compatible with standard PCB processes. For example, the method for fabricating the anode board 10a includes cutting CCL substrate into desired size, drilling through holes 320a on the anode charge collector 310, wherein, preferably, the combined area of the through holes 320a is about 40% the surface area of the anode charge collector 310, thereafter depositing a chemical copper-plating layer on the CCL substrate and on the interior surface of the through holes 320a, masking the CCL substrate with a dry film to expose the anode charge collector 310, using the dry film as a plating mask, plating a copper layer and a Sn/Pb layer on the regions that are not covered with the dry film, stripping the dry film, etching away the copper layer and the chemical copper-plating layer from the regions that are not covered with the Sn/Pb layer, and etching away the Sn/Pb layer.

According to this invention, the anode board 10a may be made of flexible board, rigid board, or rigid-flex board. The anode board 10a further comprises a bendable conductive lug 310a. Preferably, the conductive lug 310a is composed of flexible board that facilitates the parallel or serial connection between the cell units. Of course, in addition to the aforesaid bendable conductive lug 310a, the parallel or serial connection between the cell units may be accomplished by using metal plate, wire point soldering or conventional soldering methods, preferably, wire point soldering. When a metal plate is used, the metal plate is bended first, and then point soldered to fix and conduct. In a case that an extra metal is used, direct soldering may be used when the distance is short. In a long distance case, a conductive member such as wire is soldered with conductive metals such as tin. For example, one end of the wire is pulled to the edge of the plate and soldered to achieve parallel or serial connection between cell units. The parallel or serial connection of cell units of flat panel fuel cell is problematic. The present invention can solve this problem by using PCB process to fabricate the cathode or anode board.

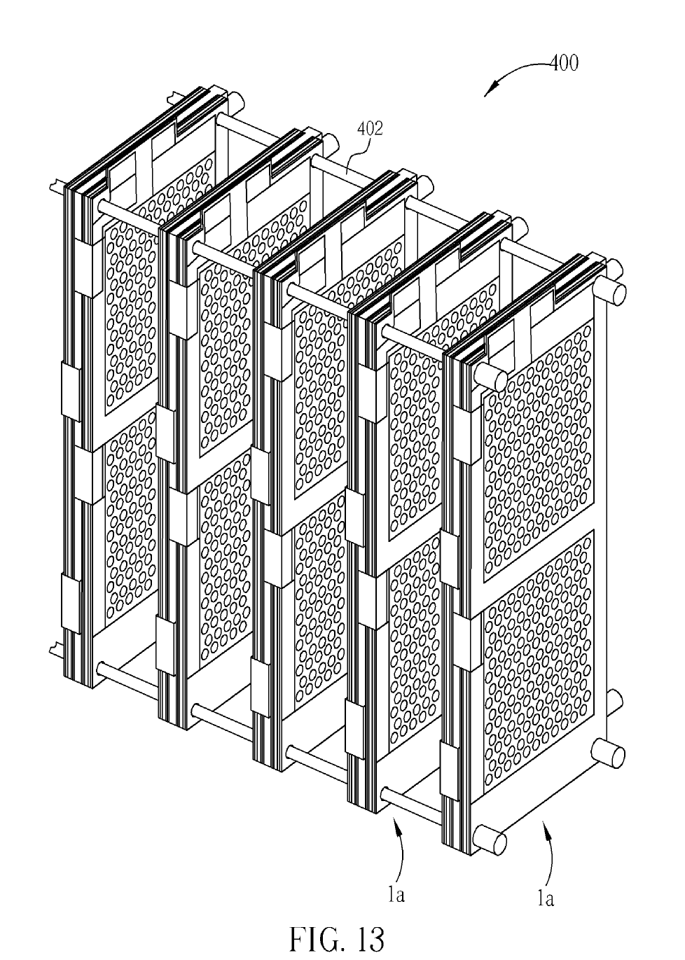

FIG. 13 is an assembly diagram of a fuel cell system 400 of this invention. As shown in FIG. 13, the fuel cell system 400 is composed of a plurality of fuel cell modules 1a. A locking member 402 such as rivet, screw or any suitable physical locking and fastening means is used to fix the plurality of fuel cell modules 1a. The locking member 402 passes through corresponding through hole disposed at each corner of each of the fuel cell modules 1a. The locking member 402 can maintain desirable spacing between the fuel cell modules 1a. The locking member 402 may be used to conduct electric current between the fuel cell modules 1a. It is understood that the fuel cell modules 1a maybe replaced with the fuel cell module 1 in FIG. 2. Further, the present invention fuel cell module is applicable to various fuels such hydrogen, methanol or the like.

Those skilled in the art will readily observe that numerous modifications and alterations of the device and method may be made while retaining the teachings of the invention.

What is claimed is:

1. A fuel cell module, comprising:
an integrated anode flow board comprising flow board, wherein a recess is formed a side of the flow board for accommodating an outward protruding conductive lug of an anode charge collector;
a cathode board comprising at least one cathode charge collector, wherein the conductive lug of the anode charge collector is bendable and is electrically connected to the cathode board;
an array membrane electrode assembly (array MEA) disposed between the integrated anode flow board and the cathode board, wherein the array MEA comprises at least one MEA unit and a proton exchange membrane; and
a pre-molded adhesive plate disposed between the integrated anode flow board and the array MEA and between the cathode board and the array MEA, wherein the pre-molded adhesive plate has an opening for accommodating the MEA unit, wherein the pre-molded adhesive plate consists of a middle frame sandwiched about two adhesive layers.

2. The fuel cell module according to claim 1 wherein a first adhesive film is disposed in the recess between the flow board and the conductive lug, and wherein a second adhesive film and the first adhesive film encapsulate the conductive lug inlaid in the recess.

3. The fuel cell module according to claim 2 wherein the integrated anode flow board further comprises a frame laminated on the second adhesive film.

4. The fuel cell module according to claim 1 wherein the adhesive layers comprise prepreg, epoxy resins, polyurethane (PU) resins or silicone resins.

5. The fuel cell module according to claim 1 wherein the proton exchange membrane comprises fluoride type proton exchange membranes or hydrocarbon type proton exchange membranes.

6. The fuel cell module according to claim 1 wherein the MEA unit is fixed on the proton exchange membrane.

7. The fuel cell module according to claim 1 wherein a positioning hole is provided on corresponding position on the integrated anode flow board, the cathode board, the array MEA and the pre-molded adhesive plate.

8. The fuel cell module according to claim 1 wherein compression of the MEA unit is controlled by adjusting thickness of the middle frame of the pre-molded adhesive plate.

9. The fuel cell module according to claim 1 wherein compression of the MEA unit is controlled by adjusting total number of the pre-molded adhesive plates used in the fuel cell module.

10. The fuel cell module according to claim 1 wherein a dummy metal pattern for radiating heat is disposed on the cathode board.

11. The fuel cell module according to claim 1 wherein an electronic device is embedded on the cathode board.

12. The fuel cell module according to claim 11 wherein the electronic device comprises active electronic devices or passive electronic devices.

13. The fuel cell module according to claim 1 wherein the flow board comprises a plurality of flow channels, and wherein the flow channels are bar type or serpentine type flow channels.

14. The fuel cell module according to claim 1 wherein a body substrate of the flow board is made by injection molding methods.

15. The fuel cell module according to claim 1 wherein the flow board is made of injection moldable polymer materials.

16. The fuel cell module according to claim 15 wherein the injection moldable polymer materials comprise polyetheretherketone (PEEK), polyetherketoneketone (PEKK), Polysulfone (PSU), liquid crystal polymer (LCP), polymer plastic substrate or a compound of engineering plastic.

17. The fuel cell module according to claim 1 wherein the cathode charge collector is fabricated by PCB process.

18. A fuel cell module, comprising:
an anode board made of rigid-flex board, wherein the anode board comprises an anode charge collector and a bendable conductive lug, and wherein a plurality of through holes are provided on the anode charge collector;
a flow board having thereon a plurality of flow channels;
a cathode board comprising at least one cathode charge collector;
an array membrane electrode assembly (array MEA) interposed between the anode board and the cathode board, wherein the array MEA comprises at least one membrane electrode assembly and a proton exchange membrane; and
an adhesive layer interposed between the anode board and the array MEA and between the cathode board and the array MEA, wherein the adhesive layer has an opening corresponding to the MEA.

19. The fuel cell module according to claim 18 wherein the conductive lug is made of flexible board, metal sheet or extra metals.

20. The fuel cell module according to claim 18 wherein a dummy metal pattern for radiating heat is disposed on the cathode board.

21. The fuel cell module according to claim 18 wherein an electronic device is embedded on the cathode board.

22. The fuel cell module according to claim 21 wherein the electronic device comprises active electronic devices or passive electronic devices.

23. The fuel cell module according to claim 18 wherein the flow board comprises a plurality of flow channels, and wherein the flow channels are bar type or serpentine type flow channels.

24. The fuel cell module according to claim 18 wherein a body substrate of the flow board is made by injection molding methods.

25. The fuel cell module according to claim 18 wherein the flow board is made of injection moldable polymer materials.

26. The fuel cell module according to claim 25 wherein the injection moldable polymer materials comprise polyetheretherketone (PEEK), polyetherketoneketone (PEKK), Polysulfone (PSU), liquid crystal polymer (LCP), polymer plastic substrate or a compound of engineering plastic.

27. The fuel cell module according to claim 18 wherein the anode charge collector is fabricated by printed circuit board (PCB) process.

28. The fuel cell module according to claim 18 wherein the cathode charge collector is fabricated by PCB process.
